(19) United States
(12) Patent Application Publication
(10) Pub. No.: US 2011/0162509 A1
(43) Pub. Date: Jul. 7, 2011

(54) APPARATUS FOR USING A PERSON'S HIPS TO CARRY THE LOAD OF MARCHING PERCUSSION EQUIPMENT OR OTHER OBJECTS WHICH ARE CARRIED NEAR WAIST-HEIGHT AND IN FRONT OF A PERSON

(75) Inventors: Ned Allen Place, Arlington, TX (US); Mikel Rust Shelton, Arlington, TX (US)

(73) Assignee: MRS NAP LLC

(21) Appl. No.: 12/655,772

(22) Filed: Jan. 7, 2010

(51) Int. Cl. G10D 13/02

(52) U.S. Cl. 84/421

(57) ABSTRACT

The MRS NAP apparatus is disclosed for carrying marching percussion or other objects, particularly but not exclusively drums of various sizes and amalgamations and other objects carried at a person's frontal area near waist height. The apparatus is worn about the user's waist and the utility uses the person's hips to bear the instrument's load. Current state of the art places a majority of the load upon the shoulders and spine. The apparatus relieves the shoulder and spine of weight and pressure and also allows more upper body movement. The MRS NAP apparatus consists of an exoskeleton load bearing frame for a solid platform to hold the carried object stably, an endoskeleton padded for comfort, a vertical spinal column brace, and straps from the apex of the spinal column brace for stability of larger objects. The MRS NAP apparatus is adjustable for various consumers of diverse sizes.

Apparatus for using a person's hips to carry the load of marching percussion equipment or other objects which are carried near waist-height and in front of a person.

### BRIEF DESCRIPTION OF THE SEVERAL VIEWS OF THE DRAWINGS

FIG. 1 Frontal View of the apparatus

FIG. 2 Left Side View of the apparatus

FIG. 3 Right Side View of the apparatus

### DETAILED DESCRIPTION OF THE PREFERRED EMBODIMENTS

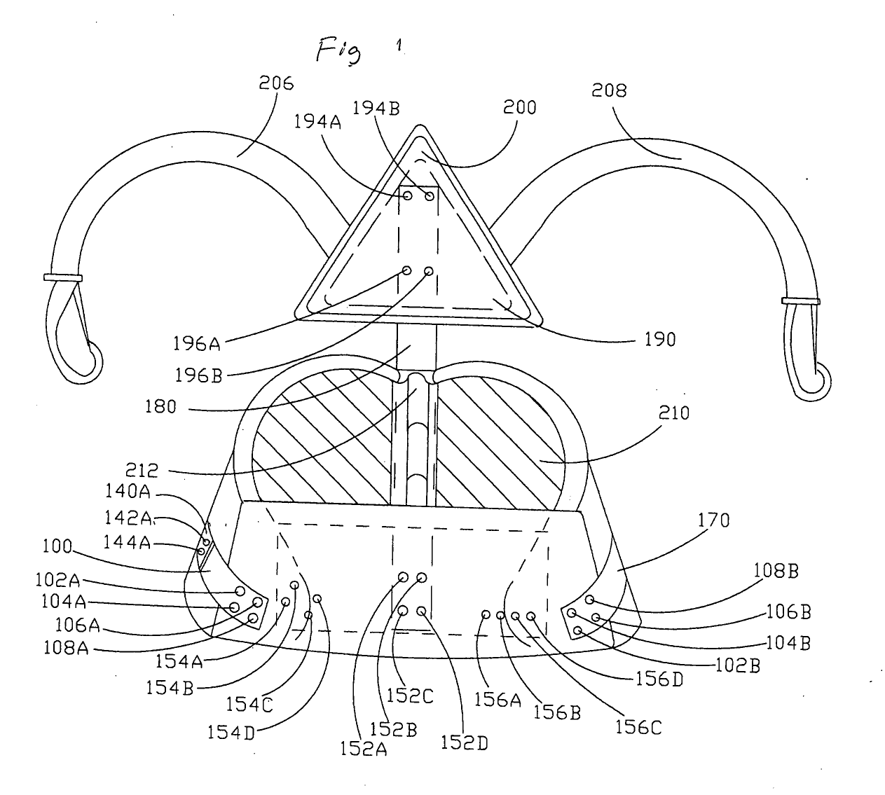

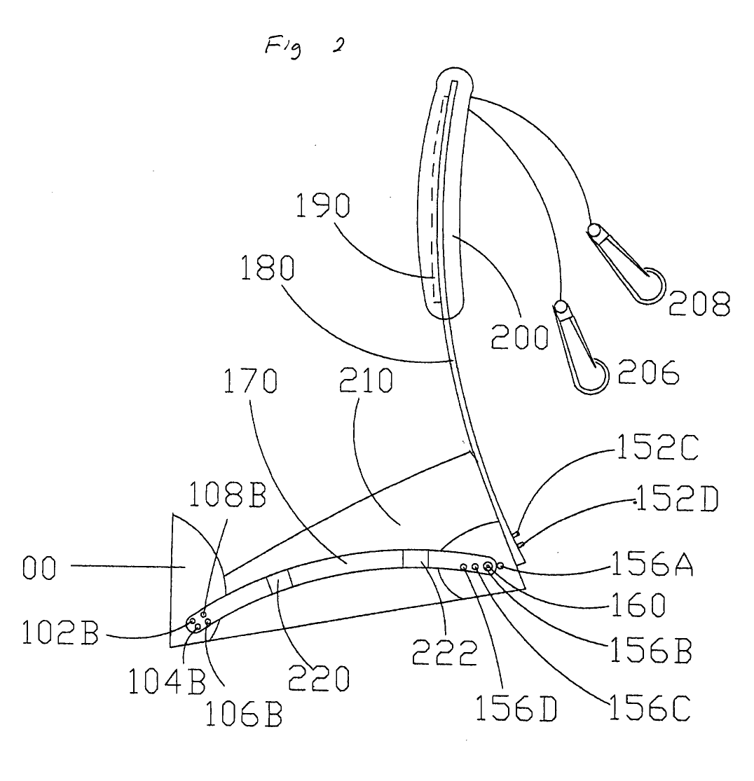

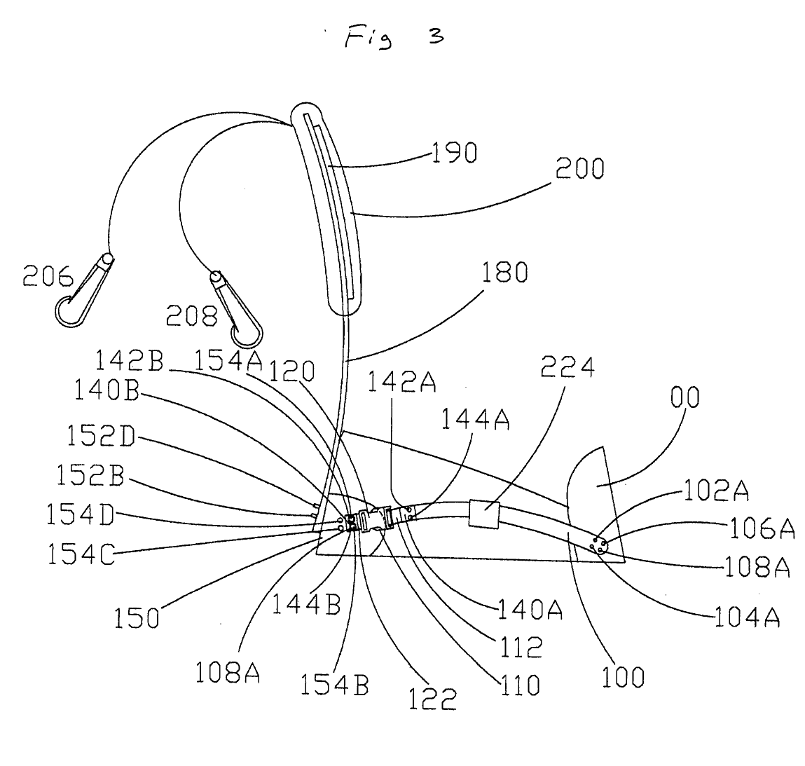

As shown in FIGS. 1, 2, and 3, the apparatus consists of a front member 00 connected to the side members 100 and 170 by a secure and rigid connection. Side members 100 and 170 are of a material, thickness, and convex curves away from the wearer to allow stability of the exoskeleton and have the flexibility necessary for this apparatus to function as designed. These side members 100 and 170 are connected to the back plate member 150 by a secure but not rigid connection. This is accomplished on the left side by a bolt and locking nut 160. This approximate ⅜ inch gap between the side members 100 and 170 and the back member 150 is necessary for this apparatus to function as designed. The right side member is attached to the back plate member by a snap connector providing similar flexibility plus a way for the consumer's ingress and egress to the apparatus. Spinal brace 180 rises from the center of the back member. The Front Plate Member must be on a plane lower than the Back Plate Member. This allows for required positioning of the carried object and the proper support for the carrying person. The endoskeleton 210 is a tapered padded material for the wearer's comfort. The endoskeleton is tapered to accommodate the wearer and the requirements of the exoskeleton. The endoskeleton and spinal brace pad 200 are easily removable for washing.

The Front Member (00) is the member of the Apparatus where percussion or other instruments are attached to the Apparatus and must be of a material to allow nominal flexing.

The Front Member (00) is attached to the side members with a rigid connection at an angle that allows the front plate to be on a plane lower than the back plate.

The Right Hip Member (100) consists of a metal or other material member approximately 10″ long by approximately 1.5″ wide that is curved in a single plane at an approximate upward 45° curve. The Right Hip Member (100) attaches to the front plate member (00) at the bottom right hand side with a secure and rigid connection of at least two points to maintain the upward curve. The member's initial contact point of approximate 45° angle must be maintained to ensure the front plate member is held at a perpendicular plane to the percussionist or other consumer. (comparison U.S. Pat. No. 5,060,836—prior patent had no angle but assumed static tension front to back). The member attaches to back plate member (150) by snap connector or other fastener (110 & 120). The tensile strength and thickness should allow for flexing of the metal or other material strip of the right hip member but hold its general curved angle.

A snap connection consists of a plastic or other material male (110) and female (120) connection or other connector attached to the adjustable webbing strap or other material (112 & 122). The webbing or other connector is approximately 17″ long on the male side (112) and 13″ long on the female side (122), using approximately 4″ each to hold it in place and approximately 13″ and 9″, respectively, available for adjustment on the member. The male portion of the snap connection or other connector is attached to right hip plate member via a pressure plate over the end of the web strap member (114). Attachment to the right hip plate member is in the same plane as the hip plate member as if it were an extension of the hip plate member. The female portion of the snap connection member or other connector is attached to the bottom edge of the right side of the back plate member at an approximate 45° angle via a pressure plate over the end of the web strap member (122).

Both the male and female portion of the snap connection or other connector is adjustable on the webbing or other material member allowing for custom sizing to the percussionist consumer and for easier entrance and egress (116). At the consumer entrance, the loose male connector or other connector member would attach to the female connector or other connector member and then the percussionist consumer would adjust the webbing strap or other adjustment member to sufficient tightness to ensure proper function of the hip strap member.

The back plate member (150) has an approximate curve of 45° to fit around the consumer's back and is approximately 14″ long and approximately 4″ wide. It consists of metal or other material to allow nominal flexing end to end and nominal torque from side to side. The right side has at least two holes to attach the pressure plate member for the female snap connector or other connector member (152). To attach the back brace member (154), the center of the back plate member has at least four holes; two on each side of a center line approximately ½″ from the center and approximately two inches apart from top to bottom; beginning approximately ½ from the bottom of the plate member. The left side of the back plate member has several horizontal holes for purposes of attaching the left hip plate member to the back plate member. The different horizontal holes allow for adjusting the overall size of the apparatus to fit different consumers. The holes are of sufficient size to accommodate a quarter inch bolt or similar pivot apparatus (156).

The pivot apparatus member (160) is used to attach the left hip plate member (170) to the back plate member. The member consists of a bolt and nut type apparatus or other connector (162 & 164) that goes through the left hip plate member and back plate member fitting them tight enough to press the two plate members together, and loose enough to allow some pivot action between the back and left hip plate members.

The Left Hip Member (170) attaches to the front plate member at the bottom left hand side with a secure and rigid connection. The member's initial contact point of approximate 45° angle must be maintained to ensure the front plate member is held at a perpendicular plane to the percussionist or other consumer. The Left Hip Member attaches to the front plate member (00) at the bottom left hand side with a secure and rigid connection of at least two points to maintain the upward curve. It is made of a metal or other material strip member approximately 15″ long by approximately 1.5″ wide curved in a single plane to an approximate 90° curve. Its purpose is to hold the front plate member in proper position and attaches the front plate member to the remainder of the hip strap member. The member attaches to back plate member by way of pivot apparatus member (160). The tensile strength and thickness should allow for allow for flexing of the metal or other material strip of the right hip member but hold its general curve angle.

The Spinal Column Brace Member (180) consists of a metal or other material strip member approximately 14″ long by approximately 1.5″ wide mounted vertically from the center of the back plate member (150) using the four holes in the center of the back plate member (extending approximately 10″ above the top of the back plate member). The spinal column brace member base has four holes that align with the four holes in the back plate member allowing the spinal column brace member to extend from the base of the back plate member. The member attaches by small nuts and bolts or other fasteners. The spinal column brace member has a 5° angle to conform to the curvature of the human spine. This angle is adjustable to conform to different spinal curvatures.

A triangle shaped Spinal Column Brace Pinnacle Member (190) attaches to the spinal column brace at approximately 8″ from the bottom of the spinal column brace member. The member is an equilateral triangle or similar shape made of metal or other material approximately 4″, centered on the spinal column brace, beginning at approximately 8″ from the base of the back plate member. It is held to spinal cord brace member with small four small bolts and nuts or other fasteners (194, 196).

The Spinal Column Brace Zenith Triangle Padding Member (200) consists of a thick pad toward the consumer wearer held. in place by Velcro or other material straps or molded around the Spinal Column Pinnacle Member (190). Optional shoulder strap members may be attached to the spinal column brace zenith padding member for larger percussion instrument stability (206, 208). If the strap configuration is used, the weight transferred to the shoulders is incidental and minimum.

The Endoskeleton of the apparatus consists of a Padded Hip Belt Member (210) on the inside of the four plate members used to cushion the percussionist from the metal or other material plates of the exoskeleton. The function of the member is to act as a hip strap to support the weight of the plate members and the percussion instrument attached on the front plate. The member is made of material such as a rip-stop nylon or other material covering a polyurethane or other material, type pad. The padded hip belt member is removable for cleaning. The padded hip belt member height is approximately 7.5″ at the back plate member tapering to approximately 5″ at the front plate member. The middle section of the rear of the belt is an approximately 6″ wide non-padded section that will allow for multiple size adjustments (212).

The padded hip belt member attaches to the plate members using straps of other connectors circling the plate members at various locations. The straps or other connectors will use Velcro or other materials to attach the endoskeleton to the exoskeleton. The left and right plate members will require one to two straps to hold the padded hip belt member in place (220,222, 224). The back place member will require two or more connectors placed on either side of the back plate member connections.

1. (canceled)

2. A load bearing apparatus worn about the hip to support the weight and force vectors of objects carried near the frontal area and attached to the apparatus through a front plate member at approximately hip height wherein, the improvement to the apparatus is that the front plate member is on a lower plane than the back plate member providing a more stable apparatus for carrying percussion instruments or other objects.

3. Left and right side members wherein, the improvement is for the members to attach to the front member at approximately a 45° angle near the edges of the front plate providing the mechanism for the front member being in lower plane than the back member.

4. Left and right side members wherein, the improvement is they are of a material providing sufficient rigidity to hold the exoskeleton stable and being sufficiently flexible to allow for the increased curve of the member as the apparatus is attached and fitted to the consumer.

5. Left and right side members wherein, the improvement is they attach to the back member in such a fashion to hold the apparatus in place and providing for additional curvature of the left and right side member as described in claim 4.

6. A Semi-rigid exoskeleton and padded endoskeleton that fully encompasses the consumer around the waist utilizing the curved members to form a snug but comfortable fit allowing for the support of the carried object without placing any weight or forces on the wearer's shoulders or other parts of the upper torso.

7. An endoskeleton wherein, the improvement is that it is of sufficient height to pad the consumer from the rigid nature of the exoskeleton and whose height tappers from back to front along the side members forming a comfortable fit for the consumer.

8. A spinal column brace projecting up from the center of the back brace parallel to the spine wherein, the improvement to the spinal column brace includes an angle to allow conformity to the curvature of the human spine.
